(19) United States
(12) Patent Application Publication
(10) Pub. No.: US 2026/0269761 A1
(43) Pub. Date: Sep. 10, 2026

(54) ELECTRIC MOTOR MODULATION MODE SWITCHING ARCHITECTURE

(71) Applicant: Silicon Mobility SAS, Valbonne (FR)

(72) Inventors: Eric MINIERE, Valbonne (FR); Farid TAHIRI, Valbonne (FR); Khaled DOUZANE, Valbonne (FR)

(21) Appl. No.: 19/168,340

(22) PCT Filed: May 16, 2023
(86) PCT No.: PCT/EP2023/063179

§ 371 Date: Sep. 24, 2025

(51) Int. Cl. H02P 27/08; H02P 21/00; H02P 21/18

(52) U.S. Cl. CPC H02P 27/085; H02P 21/0021; H02P 21/18

(57) ABSTRACT

The invention relates to the field of (digitally controlled) electric motors, (digital) control system, (electric) motor based system including those (digital) control system and methods pertaining thereto. The invention addresses the complexity of dynamically switching between two or more different modulation algorithms such as SVPWM (Space Vector Pulse Width Modulation), SPWM (Sinusoidal Pulse Width Modulation), THIPWM (Third Harmonic Pulse Width Modulation), DPWM (Discontinuous Pulse Width Modulation), OPP (Optimized Pulse Pattern).

### FIELD OF THE INVENTION

The invention relates to the field of (digitally controlled) electric motors, (digital) control system, (electric) motor based system including those (digital) control system and methods pertaining thereto.

### BACKGROUND OF THE INVENTION

This invention applies in the context of electric machine digital control algorithm, and more specifically to the control of synchronous electric motors through inverter power stage.

The invention addresses the complexity of dynamically switching between two or more different modulation algorithms such as SVPWM (Space Vector Pulse Width Modulation), SPWM (Sinusoidal Pulse Width Modulation), THIPWM (Third Harmonic Pulse Width Modulation), DPWM (Discontinuous Pulse Width Modulation), OPP (Optimized Pulse Pattern).

In this context, the “modulation” is the digital function that permits to generate best sinusoidal waveforms of electric motor coils through multi-phase inverter module as shown in FIG. 01.

Depending on the motor setpoint (torque/speed) it has been shown that some kind of modulation are more efficient than others, for example, at low speed the SVPWM modulation is more efficient. Therefore, being able to dynamically switch from one modulation to another one is key for reaching better efficiency all over the motor operating points.

In the above motor control architecture, the typical modulation architecture consists in a repetitive real-time loop that is executed at a specific rate (called “sample rate”).

The different steps in this loop may slightly differ from one modulation mode to another. Though, the following global sequence applies to all modes as shown in FIG. 2:
(0201): Field oriented control (FOC) function. This stage is common to any modulation algorithm. Its role is to provides an information about the current angular positions of the motor and the difference between the actual and target operating point.
(0202): Modulation algorithm that interprets the information from FOC stage and compute the necessary power stage switch digital commands that are applied to power stage transistor gates.
(0203): Electric motor phase current measurement stage. This is typically a set of analog to digital converters (ADC) that gives accurate information about current motor state.
(0204): Clarke and Park transform function to convert tri-dimensional motor phase information into dual-dimensional Id/Iq information.
(0205): Regulation of Id/Iq information. This is typically done with a proportional/Integral digital filtering stage.

As illustrated in FIG. 2, the (digital) control system requires amongst other functions like phase current measurement (estimation) from in the input two essential functions, in particular regulation and modulation.

Optimal control of (electric) motors require selection an appropriate modulation method as a function of the operating conditions of the (electronic) motor, defined for instance the velocity and torque required.

While a straightforward realization would be providing a parallel set of devices, realizing their implemented modulation method (as shown in FIG. 3), this creates in compatibility with the regulator and a further straight forward solution to this (as shown in FIG. 4), is to provide parallel set of devices, realizing their implemented regulation method.

Such approach results in substantial hardware overhead.

As mentioned in introduction, the efficiency of a given modulation algorithm depends on then actual operating point of the electric motor (torque & speed). The objective is to provide maximal efficiency across all possible operating conditions of the electric vehicle. So, there is a clear benefit to be able to switch from one modulation to another one dynamically depending on motor state. In essence, this principle can be summarized as shown in FIG. 03, showing in ideal vision of the multi-modulation principle.
An additional logic is required. This one is responsible to choose the best modulation algorithm depending on the actual motor operating state.
(0302): A set of modulation algorithms are available for selection.
(0303): An output multiplexer is controlled by the mode selection controller (0301) to applies the selected one to the output power stage transistors.

This “ideal” concept raised several issues (presented below) that must be solved to have a realistic system.

The different modulation algorithms do not share the exact same sample rate. For example, an SVPWM modulation operates on a fixed frequency loop, whereas OPP modulation does not operates on a fixed frequency but on the electrical frequency proportional to the motor rotation speed.

The problem is that the regulation stage (0205) is a digital filter which parameters must be aligned to the current sampling rate for proper frequency response. In other words, changing the sampling rate without changing the regulators parameters in accordance will lead to improper motor control.

An important condition to be respected when dealing with inverter power stage presented in FIG. (01) is the obligation to prevent any situation where “upper” side and “lower” side transistors could be “passing” simultaneously (which is obviously a short circuit situation).

Ideally speaking, this means that “upper” and “lower” transistors are either:
Systematically controller in opposite state
Both “open” (which is what we call a “free wheel” state)

If all the modulation algorithms comply with those condition, then we could imagine that switching from one to the other will not create short-circuit situation.

The problem is that, in reality, because of the propagation delays between digital control and transistor gates, simultaneous transition on output of the control can lead to slightly mis-aligned transition at transistor gate. So, we can have transitory states where short-circuit condition arises.

This is a well-known problem and we can take the assumption that each modulation algorithm embeds the proper “dead-time” insertion to prevent unsafe situation.

But, when switching between modulations may lead to same problem because modulations are not synchronized.

Moreover as shown in the prior-art solution in FIG. 4.
(0401): There is one regulator associated to each modulation algorithm. This permits to have regulator parameters aligned with the specific sample rate of each modulator.
(0402): In this case, each modulator does not provide any dead-time insertion function.

This prior-art solution has a complexity problem because
First, having multiples regulators is any obvious waste of resource because they are basically all the same (except for the parameters), and only one of them is in used at any time.
Also, the regulator output must be synchronized at mode switching time so that the mode transition is smooth. This synchronization is not obvious because of the different sample rates of each modulation and usually leads to complex sequences.

### AIM OF THE INVENTION

It is the aim of the invention to enable fluent require selection an appropriate modulation method as a function of the operating conditions of the (electronic) motor while avoiding the substantial hardware overhead, in particular the technical considerations made here enable that more modulation methods can be made available.

### SUMMARY OF THE INVENTION

In a first aspect of the invention a (digital) control system for regulating and modulating (digitally controlled) electric motors, comprising: (1) a regulating device (0501); (2) a plurality of modulating devices (0504); (3) a selector (0510) for selecting one of the output signals provided by said modulating devices; and (4) a controller (0503) for (a) steering the selection by said selector and (b) providing said regulating parameters (0502) to said regulating device.

In the embodiment shown in FIG. 5, 6, 7 or 8, in essence there is a single regulating device, compared to a plurality of modulating devices, or phased differently, the deliberate choice is made to have less regulating devices than modulating devices, which requires that the regulating device needs to use regulating parameters such that a regulating method aligned with the modulating method is used.

In an alternative embodiment of FIG. 13 the (digital) control system for regulating and modulating (digitally controlled) electric motors, comprises: (1) one or more regulating devices; (2) a plurality of modulating devices, said modulating devices being dedicated to one of said regulating devices, all inputting the signal from their associated regulating devices; (3) a selector for selecting one of the output signals provided by said modulating devices (and thereby selecting that modulating devices as active modulating device); and (4) a controller for (a) steering the selection by said selector and (b) providing said regulating parameters to the related one of said regulating devices. While here the choice is made to use more than one regulator, still the deliberate choice is made to have less regulating devices than modulating devices.

In an embodiment of the invention there are at least two modulating devices, preferably three. In the embodiment of the invention with two modulating devices, there is at most one regulator with programmable parameters. In the embodiment of the invention with three modulating devices, there can be one or more regulating devices, whereby the one serving two modulating devices should have programmable parameters.

The invention shows in FIGS. 5 and 6 an embodiment using a multiplexer. Note that in this embodiment because some of the modulators are no longer fed with data they are actually stopped.

However FIGS. 7 and 8 show embodiments with direct connections. Note that in this embodiment because all of the modulators are fed with data and can operate at the maximum sampling rate frequency, they can continue to run in parallel. The power consumption overhead in this particular solution is neglectable since there are running at a reasonable frequency. On the contrary, the fact that they run in parallel continuously is a guarantee of better switching from one modulation to another. Triggering or restarting them at the moment of switching some time before can on the contrary makes the control loop diverge at the moment of switching. This is a major advantage of this embodiment. The switching can take place at any moment. This is at the opposite of the state of the art where the switching time to another modulation is constrained. The switching to another modulation cannot take place at any time. The switching to another modulation is forced at a time when no dead time is required or, worse, all transistors circuits are opened (which result to set the motor to freewheel). This generates latency on the response time, ripples on the control, and even worse ... the control can diverge. Notwithstanding the above, in an embodiment of the invention may benefit from monitoring the gate situation in that the controller may take this into account, in that it may not need to trigger itself dead-time and/or free-wheel (open circuit) measures.

The embodiment with more regulating devices, but less than the amount of modulating devices) can also be implemented with direct connections between one or more of said regulating devices and/or direct connection between the system input and one or more of the regulating devices.

The so-called dead-time measures taken during ordinary modulation might be insufficient when switching from one regulating modulation mode, because when switching between modulations these modulations are not synchronized.

In an embodiment of the invention, besides appropriate switching methods, therefore the control system further comprises a dead-time insertion device, receiving the output of said selector and when activated inserting a dead-time period, the system being further characterized in that said controller further being adapted for activating said dead-time insertion device. To be complete, while the dead-time insertion device can act on control of the controller, it can also act autonomously or under control of signals generated elsewhere in the system. In an alternative embodiment of the invention, the presence of a dead-time insertion circuit not (directly) linked to the controller is provided.

It is worth noting that such dead-time insertion typically are to be applied per leg of the invertor. An alternative (where all legs are open circuit) is discussed below.

In an embodiment of the invention with a free wheel override device (free wheel is also denoted open circuit) one can make the following observations:

Now no additional common dead-time insertion block as such is available but in the invention, the provided modulating devices can include their own dead-time insertion function.

In the invention, one may introduce (for instance as part of the free wheel override device discussed further) a common dead-time insertion block or function based on the minimum of the dead-time required for all modulators and adapt (subtract) this from the dead-time insertion function of each modulator instead. The same considerations can be made for the embodiment with common dead-time insertion.

The so-called dead-time measures taken during ordinary modulation might be insufficient when switching from one regulating modulation mode, because when switching between modulations these modulations are not synchronized.

In an embodiment of the invention, besides appropriate switching methods, therefore the control system further comprising: (5) a free wheel override device (0505), receiving the output of said selector, the system being further characterized in that said controller further being adapted for (c) activating said free wheel override device and/or apply the dead time by leg of the invertor, preferably when the change of state of the transistor induced by the modulation change requires it.

The modulation switching sequence may rely on an additional stage in between said regulating device and said multiplexer and/or said modulators and therefore in an embodiment of the invention the control system further comprising: (6) a pipe-line stage (0506), in between said regulating device and said multiplexer (FIGS. 5, 6) and/or said modulators (FIGS. 7, 8).

In a second aspect of the invention methods for switching the regulating and modulating mode of a (digitally controlled) electric motor from a first mode to a second mode, said modes being different in either the modulation scheme or the regulating parameters used or both, said method being implemented by the controller of the first aspect of the invention, the methods having the following steps: (1) receiving a switch request (to apply a modulation technique applicable or best suited for a certain motor operating point (speed and/or torque)); (2) (a) changing the regulating device parameters to align with the modulating device of said second mode and (b) starting sampling in accordance said second mode; (2) activating said free-wheel override device for inserting a free-wheel period; (3) selecting the output signal of the modulating device of said second mode; (4) either simultaneous with (3) or thereafter de-activating said free-wheel override device. A similar method can be applied for a dead-time insertion or dead-time guard approach which introduces the dead-time per leg only if the change of state of the transistor induced by the modulation change require it.

It is worth noting that two switching methods can be used, one so-called synchronous switching and one so-called asynchronous switching, whereby the synchronous switching requires that the sampling rates of the modes to switch being a multiple of one another. Depending on the control context, one may select to use one of the methods. Moreover one may also observe (for instance if no coincidence is any more occurring within the time period expected) the conditions on the sample rates are no longer fulfilled or put otherwise that the hardware is no longer capable to operate with this condition, and hence choose to switch from the synchronous method to the other one.

In case the hardware programmable unit is elected for implementing the controller one can (re-)configuring (part of) the hardware programmable unit for such purpose.

The switching methods are discussed in the context of the free-wheel embodiment but the same considerations can be made for the dead-time insertion embodiment.

### BRIEF DESCRIPTION OF THE DRAWINGS

FIG. 1 provides the context of the invention and the place of the invented (digital) control system therein.

FIG. 2 illustrates the role of a (digital) control system.

FIG. 3 illustrates a prior-art approach with multiple modulating devices with one fixed regulating device.

FIG. 4 illustrates a further prior-art approach with multiple modulating device and multiple regulating devices (an equal amount of both).

FIG. 5 shows the invented (digital) control system, with an unequal amount of regulators (here 1) and modulating devices (here 3) with multiplexer.

FIG. 6 shows the invented (digital) control system, with an unequal amount of regulators (here 1) and modulating devices (here 3) with multiplexer and free-wheel or open circuit block. In the alternative also here a dead-time insertion block can be used.

FIG. 7 shows the invented (digital) control system, with an unequal amount of regulators (here 1) and modulating devices (here 3) with direct connections.

FIG. 8 shows the invented (digital) control system, with an unequal amount of regulators (here 1) and modulating devices (here 3) with direct connection and dead-time insertion block. In the alternative also here a free-wheel or open circuit block can be used.

FIGS. 9 and 10 illustrate the possible switching methods that can be used with the invented (digital) control signal for the free-wheel embodiment.

FIGS. 11 and 12 illustrate the possible switching methods that can be used with the invented (digital) control signal for the dead-time embodiment.

FIG. 13 shows an alternative demultiplexer embodiment of the invented (digital) control system, with an unequal amount of regulators (here 2) and modulating devices (here 3) which can be combined with free-wheel or open circuit blocks and/or dead-time insertion blocks. The direct connect approach is also possible.

### DETAILED DESCRIPTION

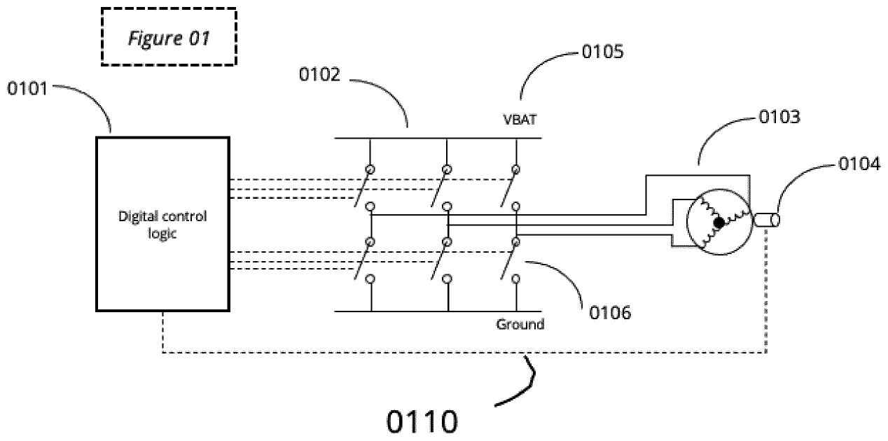

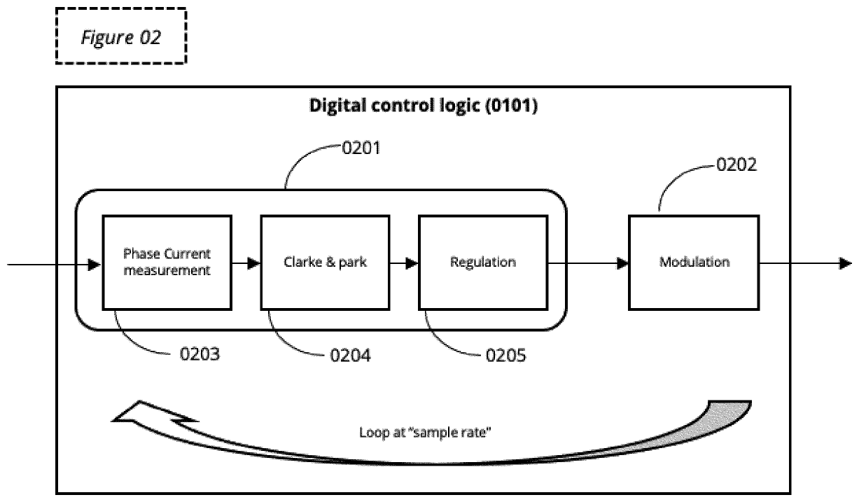

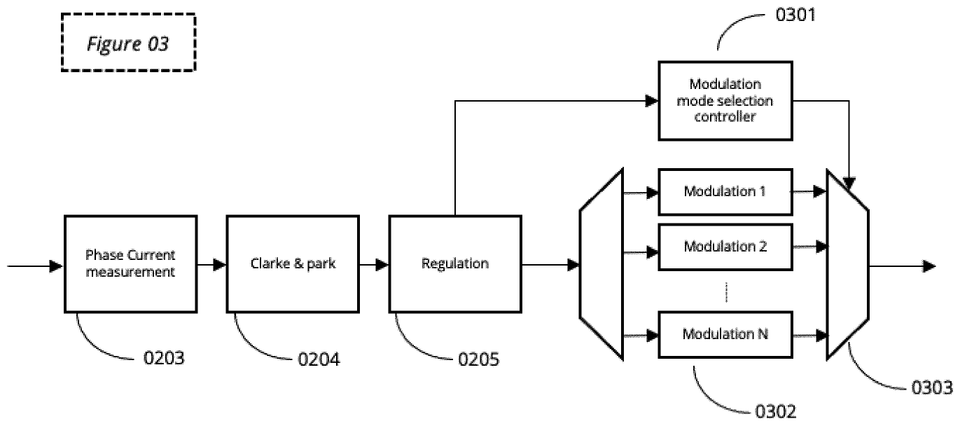

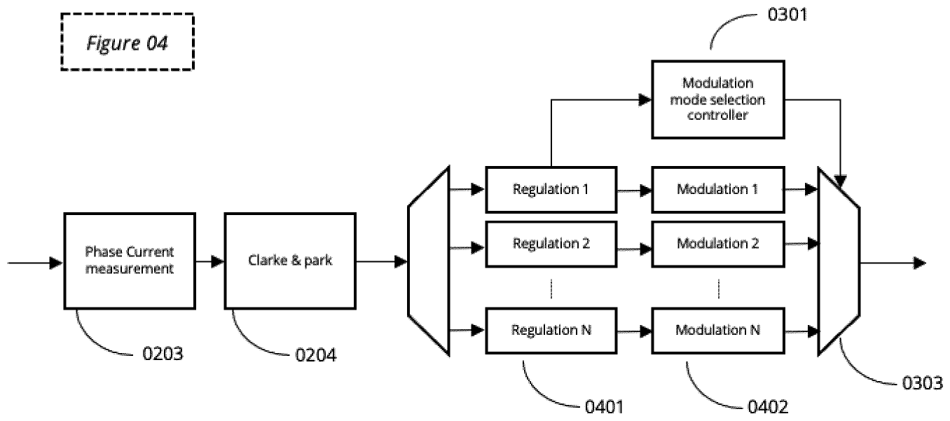

The invention relates to (digital) control system for regulating and modulating (digitally controlled) electric motors and as (electric) motor based system (as outlined in FIG. 1), comprising: (1) an (electric) motor (0103); (2) an (electric) motor power control means (0102) provided for controlling said (electric) motor; (3) a (digital) control system (0101 as described in the summary, adapted for providing control signals for said (electric) motor power control means; (4) a (electric) power storage means (0105), provided for powering said (electric) motor power control means, wherein said (electric) motor power control means comprises a plurality of pair wise serial connected switches (0106). As shown the (digital) control system provides control signals, in essence closing or opening the switches, said control signals being determined by regulating and modulating methods. Note that the control system receives input signals (0110) obtained from measurements captured on the motor.

The one or more regulating devices typically execute a a low-pass function, more in particular proportional/Integral control.

The modulators execute the digital function that permits to generate (best) sinusoidal waveforms for electric motor coils through a multi-phase inverter module, more in particular based on the information from FOC stage it computes the necessary power stage switch digital commands that are applied to power stage transistor gates.

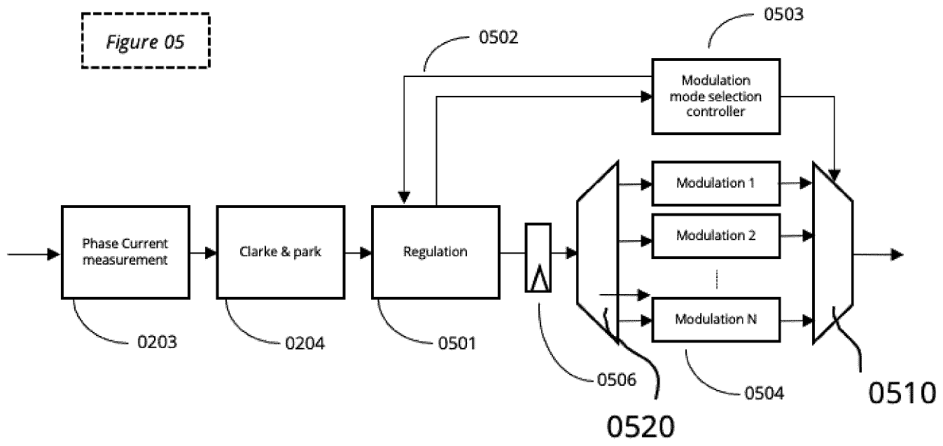

An embodiment of the invented architecture is shown in FIG. 05 and shows
(0501): The regulator stage is common to all modulation algorithms
(0502): This regulator receives regulation parameters from modulation selection logic
(0503): This module is responsible for selecting the currently applicable modulation and manages the modulation transition sequence according to following chapter
(0504): N modulations algorithms. Each of them relies on common regulator.

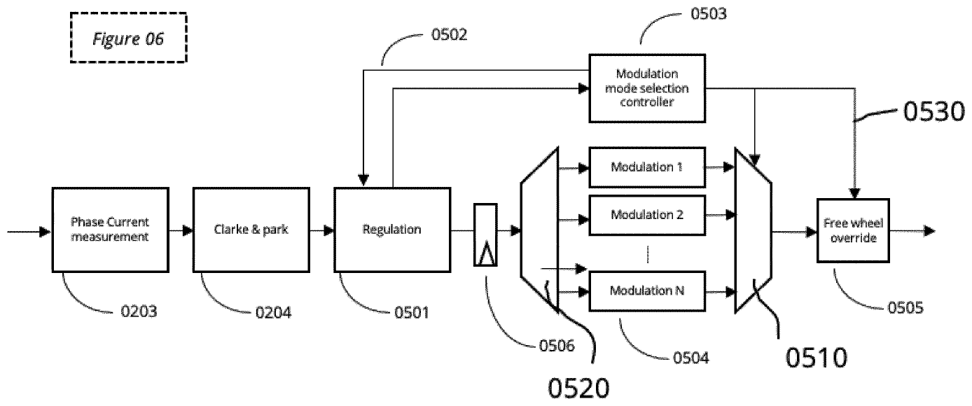

An embodiment of the invented architecture is shown in FIG. 06 and shows further
(0505): An additional override logic is responsible for “free-wheel” period insertion under (0503) control.

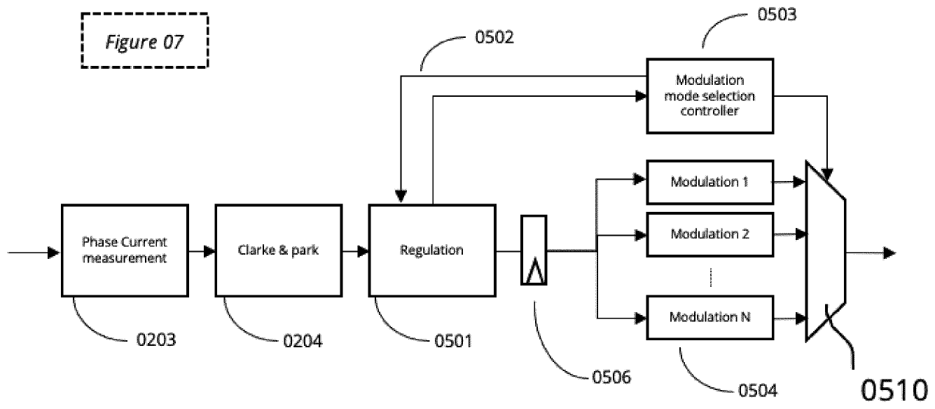

An embodiment of the invented architecture is shown in FIG. 07 and shows further
(0505): An additional override logic is responsible for “dead-time guard” under (0503) control.

For these embodiments
(0506): The modulation switching sequence may requires that, at least, one stage of digital pipe-line operating at sample rate is inserted between regulation and modulation.

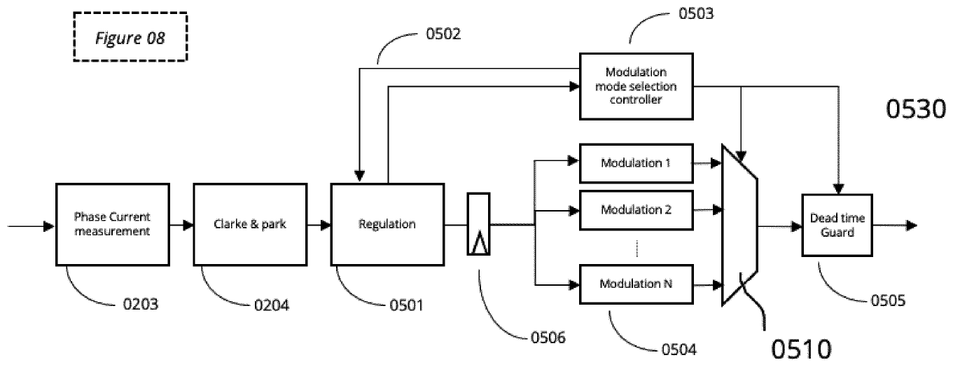

FIGS. 7 and 8 show alternatives with direct connections and/or use of a dead-time insertion block.

As indicated before the direct connection approach can be combined with the free-wheel embodiment.

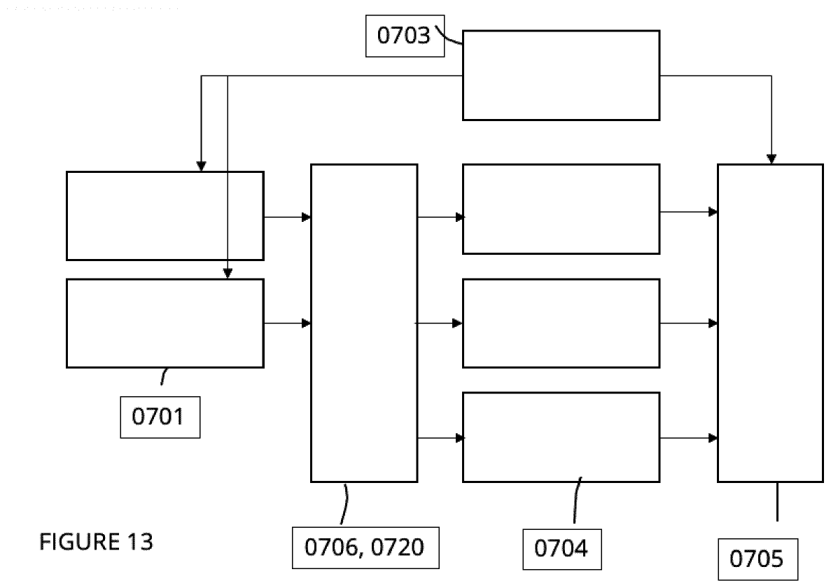

FIG. 13 shows an alternative-with two regulator stages (0701), three modulating modules (0704) and intermediate selection and pipe-line stage (0706, 0720) and further selection stage (0705). This alternative may also include the free-wheel stage.

Generally speaking a (digital) control system for regulating and modulating (digitally controlled) electric motors is provided, comprising: (1) a regulating device (0501), adapted for receiving regulating parameters (0502) to align with the active modulating device sampling rate; (2) a plurality of modulating devices (0504), each with a different sampling rate, all inputting the signal from said regulating device; (3) a selector (0510) for selecting one of the output signals provided by said modulating devices (and thereby selecting that modulating devices as active modulating device); and (4) a controller (0503) for (a) steering the selection by said selector (and thereby implicitly selects a modulating device) and (b) providing said regulating parameters (0502) to said regulating device.

The (digital) control system can further comprise one or more additional regulating devices, wherein each of said additional regulating devices are provided with their dedicated modulating device (inputting the signal of their associated regulating device); said selector, being capable of selecting also one of the output signals for those dedicated modulating devices; and a multiplexer for guiding the system input signal to either one of said regulating devices or alternatively stated the (digital) control system for regulating and modulating (digitally controlled) electric motors, comprises: (1) one or more regulating devices, adapted for receiving regulating parameters to align with the active modulating device sampling rate; (2) a plurality of modulating devices, each with a different sampling rate, said modulating devices being dedicated to one of said regulating devices, all inputting the signal from their associated regulating devices; (3) a selector for selecting one of the output signals provided by said modulating devices (and thereby selecting that modulating devices as active modulating device); and (4) a controller for (a) steering the selection by said selector and (b) providing said regulating parameters to said regulating device.

The (digital) control system may comprise (5) a free wheel override device (0505), receiving the output of said selector and when activated inserting a free-wheel period (implying all switches open in the related (electric) motor power control means), the system being further characterized in that said controller further being adapted for (c) activating said free wheel override device (via signal (0530)). In the alternative a dead-time insertion block is provided. Then the (digital) control system may comprise (5) the dead-time insertion and/or guard device (505), the system being further characterized in that said controller further being adapted for (c) activating said dead-time guard device (505) (via signal (0530)).

The (digital) control system may comprise (6) a pipe-line stage (0506), in between said regulating device and said multiplexer (or as the case may be the modulators), for temporally storing regulator output.

The invention requires a switching sequence. Two main embodiments of such sequence, denoted a synchronous switching sequence; and an asynchronous switching sequence are now described.

### Synchronous Switching Sequence

In most of the situations the sample rates of the different modulation algorithms are multiple of each other. If we take this as an assumption, the switching sequence is made easier.

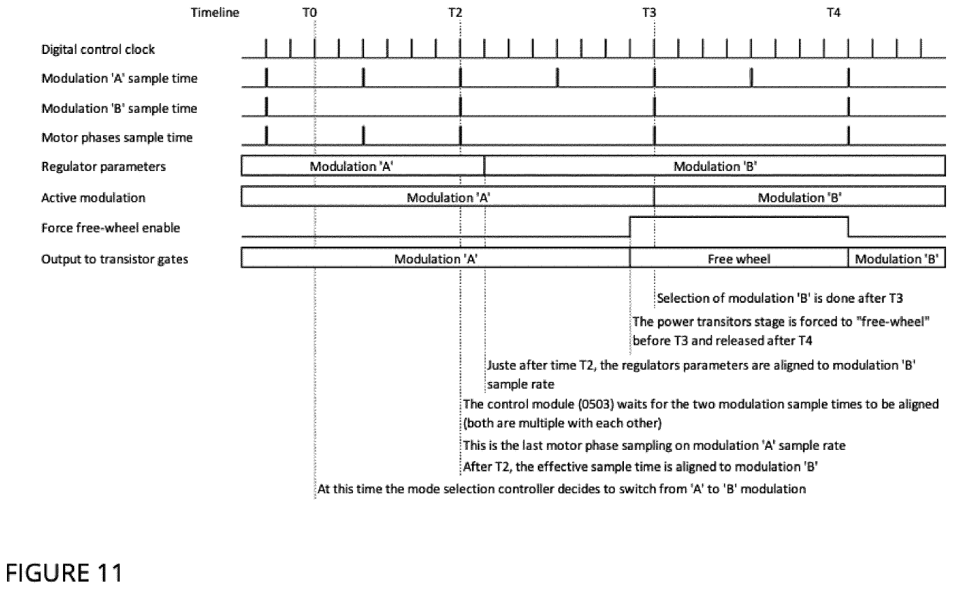

FIG. 11 explains this sequence in the context of freewheel or open circuit approach and shows the following steps:
1) Before switch, the power transistors are controlled by modulation ‘A’. In this period, the motor current phases are sampled at sample rate of modulation ‘A’
2) Eventually, the mode selection control decides for modulation algorithm change (from modulation ‘A’, to modulation ‘B’) (time TO)
3) It waits for the time where sample time of modulation ‘A’ and ‘B’ are simultaneous again. Which happens necessarily because both are multiple of each other (time T2)
4) Then it modifies the regulator parameters so that they are aligned to modulation ‘B’ sample rate. This modification shall only be effective at the next motor phase sampling time. So, at this time, the output of the regulator pipeline stage (0506) is still in application for modulation ‘A’.
5) The free-wheel state is forced on power gates to prevent dead-time violation at modulation switch time. This action must take place before effective modulation switch.
6) From time T2, the motor phase sampling events are now controlled by sample rate of modulation ‘B’
7) At next motor phase sampling time (time T3), the regulator receives new data aligned to modulation ‘B’ sampling rate, so the modulation algorithm can now be safely switched to modulation ‘B’.
8) After sufficient dead-time period, the free-wheel forced state is released (time T4)
9) Now, the transistors are fully controlled by modulation ‘B’.

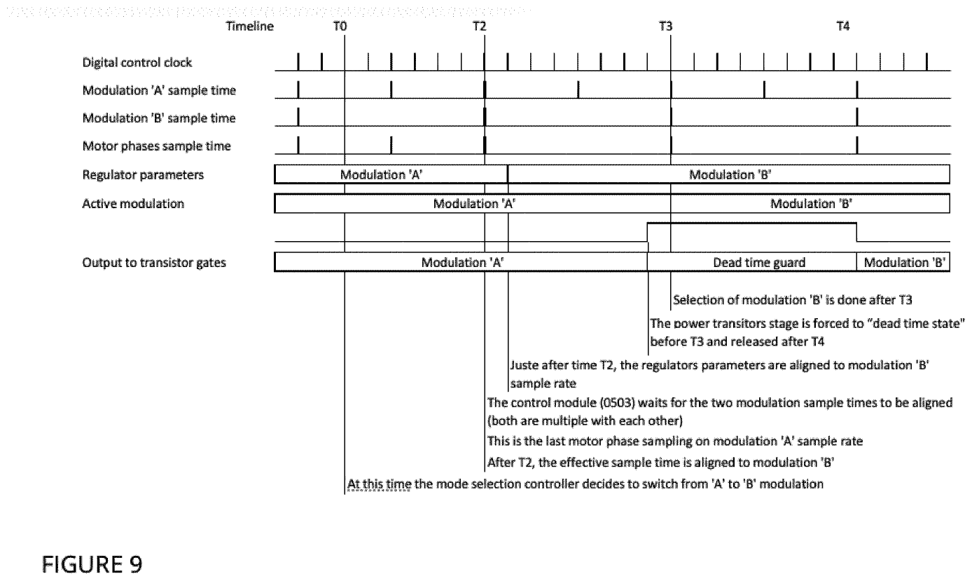

FIG. 9 explains this sequence for the dead-time guard approach and shows the following steps:
1) Before switch, the power transistors are controlled by modulation ‘A’. In this period, the motor current phases are sampled at sample rate of modulation ‘A’
2) Eventually, the mode selection control decides for modulation algorithm change (from modulation ‘A’, to modulation ‘B’) (time TO)
3) It waits for the time where sample time of modulation ‘A’ and ‘B’ are simultaneous again. Which happens necessarily because both are multiple of each other (time T2)
4) Then it modifies the regulator parameters so that they are aligned to modulation ‘B’ sample rate. This modification shall only be effective at the next motor phase sampling time. So, at this time, the output of the regulator pipeline stage (0506) is still in application for modulation ‘A’.
5) The dead-zone state is forced on power gates to prevent dead-time violation at modulation switch time if change of state of the transistor induced by the modulation change requires it.
6). This action takes place simultaneously with the modulation switch with the dead-time guard function
7) From time T2, the motor phase sampling events are now controlled by sample rate of modulation ‘B’
8) At next motor phase sampling time (time T3), the regulator receives new data aligned to modulation ‘B’ sampling rate, so the modulation algorithm can now be safely switched to modulation ‘B’.
9) Now, the transistors are fully controlled by modulation ‘B’.

The invention hence provides a method for (synchronous) switching the regulating and modulating mode of a (digitally controlled) electric motor from a first mode to a second mode, said modes, in particular the modulating operation thereof, having a different sampling rate but being a multiple of one another in a system of any of the previous claims: (1) receiving a switch request (to apply a modulation technique applicable or best suited for a certain motor operating point (speed and/or torque)); (2) at the time when the sample time of said modes coincide, (a) changing the regulating device parameters to align with the modulating device sampling rate of said second mode and (b) starting sampling in accordance with said sampling rate of said second mode; (2) activating said free-wheel override device for inserting a free-wheel period; (3) selecting the output signal of the modulating device of said second mode; (4) de-activating said free-wheel override device.

### Asynchronous Switching Sequence

In the most general situation, the different modulation sample rates are fully asynchronous with each other. So, the previous sequence cannot be used. For sake of clarity, one may also choose to use the asynchronous when this sample rate condition is fulfilled.

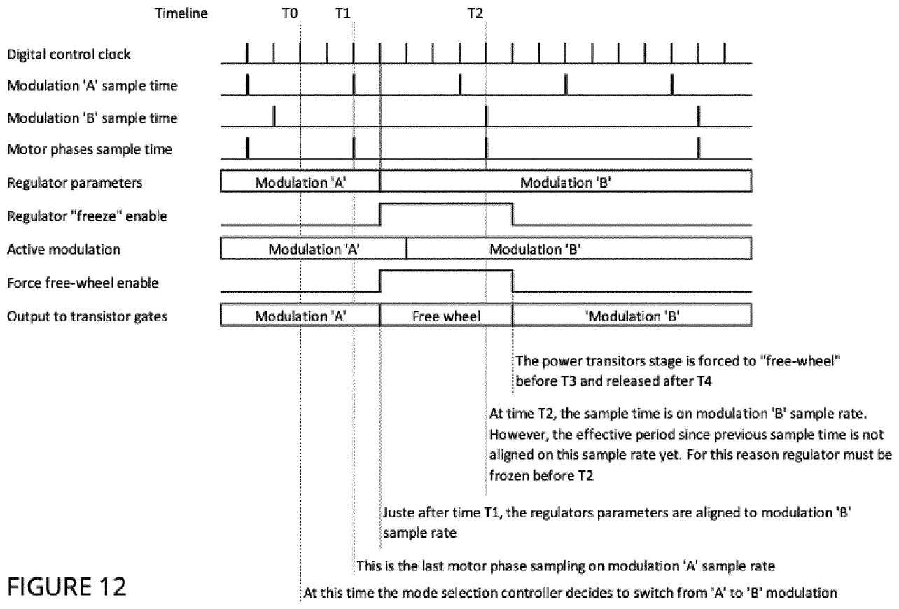

FIG. 12 explains this sequence and shows the following steps:
1) Before switch, the power transistors are controlled by modulation ‘A’. In this period, the motor current phases are sampled at sample rate of modulation ‘A’
2) Eventually, the mode selection control decides for modulation algorithm change (from modulation ‘A’, to modulation ‘B’) (time T0)
3) It waits for the next sample time of modulation ‘A’ sample rate (time T1)
4) From time T1, the motor phase sampling events are now controlled by sample rate of modulation ‘B’.
5) Then it modifies the regulator parameters so that they are aligned to modulation ‘B’ sample rate. This modification shall only be effective at the next motor phase sampling time. So, at this time, the output of the regulator pipeline stage (0506) is still in application for modulation ‘A’.
6) The free-wheel state is forced on power gates to prevent dead-time violation at modulation switch time. This action must take place before effective modulation switch.
7) From time T2, the motor phase sampling events are now controlled by sample rate of modulation ‘B’
8) However, between sample times T1 and T2 the effective period is neither the one of modulation ‘A’, nor the one of ‘B’. So, the regulators parameters are necessarily mis-aligned to this intermediate sample rate.
9) This is why the sample at time T2 must be ignores by regulator (regulator freeze) to avoid bad regulation.
10) After sufficient dead-time period, the free-wheel forced state is released (after T2)
11) At same time, regulator freeze is release to accept next sample on modulation ‘B’ sample rate
12) Now, the transistors are fully controlled by modulation ‘B’.

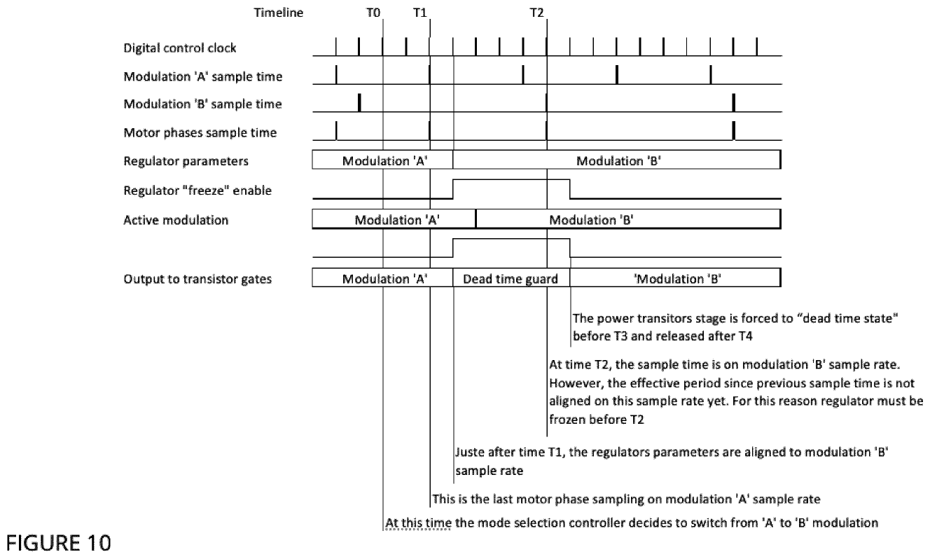

FIG. 10 explains this sequence and shows the following steps:
1) Before switch, the power transistors are controlled by modulation ‘A’. In this period, the motor current phases are sampled at sample rate of modulation ‘A’
2) Eventually, the mode selection control decides for modulation algorithm change (from modulation ‘A’, to modulation ‘B’) (time T0)
3) It waits for the next sample time of modulation ‘A’ sample rate (time T1)
4) From time T1, the motor phase sampling events are now controlled by sample rate of modulation ‘B’.
5) Then it modifies the regulator parameters so that they are aligned to modulation ‘B’ sample rate. This modification shall only be effective at the next motor phase sampling time. So, at this time, the output of the regulator pipeline stage (0506) is still in application for modulation ‘A’.
6) The dead-time state is forced on power gates to prevent dead-time violation at modulation switch time. This action takes place simultaneously with the modulation switch with the dead-time guard function.
7) From time T2, the motor phase sampling events are now controlled by sample rate of modulation ‘B’
8) However, between sample times T1 and T2 the effective period is neither the one of modulation ‘A’, nor the one of ‘B’. So, the regulators parameters are necessarily mis-aligned to this intermediate sample rate.
9) This is why the sample at time T2 must be ignores by regulator (regulator freeze) to avoid bad regulation.
10) At same time, regulator freeze is release to accept next sample on modulation ‘B’ sample rate
11) Now, the transistors are fully controlled by modulation ‘B’.

The invention hence provides a method for (asynchronous) switching the regulating and modulating mode of a (digitally controlled) electric motor from a first mode to a second mode, said modes, in particular the modulating operation thereof, having a different sampling rate (regardless of whether they are a multiple of one another) in a system of any of the previous claims: (1) receiving a switch request (to apply a modulation technique applicable or best suited for a certain motor operating point (speed and/or torque)); (2) at the next sample time of said first mode, (a) changing the regulating device parameters to align with the modulating device sampling rate of said second mode and (b) starting sampling in accordance with said sampling rate of said second mode; (2) activating said free-wheel override device for inserting a free-wheel period; (3) only after the next sampling time of said second mode, selecting the output signal of the modulating device of said second mode and de-activating said free-wheel override device. The «freeze» period introduces a transitory uncertainty in regulation. This is not a major problem because the regulator is a low-pass function that naturally filters this kind of artefact. Moreover the problem can be entirely solved by keeping always the regulator running at the maximum frequency

The two invented methods can be described as methods for switching the regulating and modulating mode of a (digitally controlled) electric motor from a first mode to a second mode, said modes, in particular the modulating operation thereof, having a different sampling rate in a system of any of the previous claims: (1) receiving a switch request (to apply a modulation technique applicable or best suited for a certain motor operating point (speed and/or torque)); (2) at a first appropriate time, (a) changing the regulating device parameters to align with the modulating device sampling rate of said second mode and (b) starting sampling in accordance with said sampling rate of said second mode; (2) activating said free-wheel override device for inserting a free-wheel period; (3) at a second appropriate time selecting the output signal of the modulating device of said second mode; (4) either simultaneous with (3) or thereafter de-activating said free-wheel override device.

FIGS. 9 and 10 illustrate the same with a dead-time insertion zone.

The above sequences impose an implicit constraint on the logic that is responsible for the execution of this sequence. The complete sequence shall be shorter that the fastest sampling rate of the modulations.

This means that this sequence cannot be handled by a software sequence on random micro-controller alone.

Therefore, the innovation is perfectly suited for an execution on a FPCU component that provides both CPU computing and embedded FPGA for hard real time sequences.

Therefore the (electric) motor based system comprises a (digital) control system comprising a software programmable unit and/or a hardware programmable unit, preferably a programmable logic matrix (adapted for hard real-time work) and hence preferably both.

Therefore within the invention one should determine whether the method, more precisely which parts of the method, will be governed by the software programmable unit or the hardware programmable unit of (digital) control system, configured for such purpose.

1. A control system for regulating and modulating electric motors, comprising:
a regulating device, adapted for receiving regulating parameters to align with the active modulating device sampling rate;
a plurality of modulating devices, each with a different sampling rate, all inputting the signal from said regulating device;
a selector for selecting one of the output signals provided by said modulating devices; and
a controller for steering the selection by said selector and providing said regulating parameters to said regulating device.

2. The control system of claim 1, wherein said selector being a de-multiplexer.

3. The control system of claim 1, further comprising: a multiplexer for guiding the output signal of said regulating device to said modulating devices.

4. The control system of claim 1, whereby the output signal of said regulating device is directly provided to said modulating devices.

5. The control system of claim 1, further comprising: one or more additional regulating devices, wherein each of said additional regulating devices are provided with their dedicated modulating device; the selector, being capable of selecting also one of the output signals for those dedicated modulating devices; and a multiplexer for guiding the system input signal to either one of said regulating devices in case the output of said additional regulating devices is not provided directly to said dedicated modulating devices.

6. The control system of claim 1, further comprising: dead-time insertion device, receiving the output of said selector and when activated inserting a dead-time period, the system being further characterized in that said controller further being adapted for activating said dead-time insertion device.

7. The control system of claim 1, further comprising: a free wheel override device, receiving the output of said selector and when activated inserting a free-wheel period, optionally the system being further characterized in that said controller further being adapted for activating said free wheel override device.

8. The control system of claim 1, further comprising: a pipe-line stage, in between said regulating device and said multiplexer and/or modulating devices, for temporally storing regulator output.

9. The control system of claim 1, said controller being adapted for executing switching methods.

10. The control system of claim 1, wherein said regulating devices are filtering devices adapted for providing information to said controller, which based thereon selects a modulating device.

11. The control system of claim 1, wherein said plurality of modulating devices support modulating techniques selected from the group of: SVPWM (Space Vector Pulse Width Modulation), SPWM (Sinusoidal Pulse Width Modulation), THIPWM (Third Harmonic Pulse Width Modulation), DPWM (Discontinuous Pulse Width Modulation), OPP (Optimized Pulse Pattern).

12. A motor based system, comprising: a motor; a motor power control means provided for controlling said motor; the control system of claim 1, adapted for providing control signals for said motor power control means; and a power storage means, provided for powering said motor power control means.

13. The motor based system of claim 12, wherein said motor power control means comprises a plurality of pair wise serial connected switches.

14. The motor based system of claim 12, wherein the control system comprises a software programmable unit and/or a hardware programmable unit, and a programmable logic matrix.

15. A method for switching the regulating and modulating mode of an electric motor from a first mode to a second mode, comprising: receiving a switch request at a first appropriate time, changing the regulating device parameters to align with the modulating device sampling rate of said second mode and starting sampling in accordance with said sampling rate of said second mode; activating said free-wheel override device for inserting a free-wheel period and/or said dead-time insertion device for inserting a dead-time; and either simultaneously with or thereafter correspondingly de-activating said free-wheel override device and/or said dead-time insertion device.

16. The method of claim 15, adapted for switching the regulating and modulating mode of an electric motor from a first mode to a second mode, said modes, having a different sampling rate but being a multiple of one another in the control system of claim 1, the method comprising:
receiving a switch request;
defining as first appropriate time the time when the sample time of said modes coincide,
changing the regulating device parameters to align with the modulating device sampling rate of said second mode and starting sampling in accordance with said sampling rate of said second mode;
activating said free-wheel override device for inserting a free-wheel period and/or said dead-time insertion device for inserting a dead-time;
selecting the output signal of the modulating device of said second mode; and
de-activating correspondingly said free-wheel override device and/or said dead-time insertion device.

17. The method of claim 15, adapted for switching the regulating and modulating mode of an electric motor from a first mode to a second mode, the method comprising:
receiving a switch request defining as a first appropriate time a next sample time of said first mode; changing the regulating device parameters to align with the modulating device sampling rate of said second mode and starting sampling in accordance with said sampling rate of said second mode;
activating said free-wheel override device for inserting a free-wheel period and/or said dead-time insertion device for inserting a dead-time;
defining as second appropriate time to be only after the next sampling time of said second mode; and
selecting the output signal of the modulating device of said second mode and de-activating correspondingly said free-wheel override device and/or said dead-time insertion device.

18. (canceled)

19. (canceled)
